(19) United States
(12) Patent Application Publication
(10) Pub. No.: US 2017/0297847 A1
(43) Pub. Date: Oct. 19, 2017

(54) Baseboard Dispensing Assembly

(71) Applicant: Brian McKnight, Eagle River, AK (US)

(72) Inventor: Brian McKnight, Eagle River, AK (US)

(21) Appl. No.: 15/131,211

(22) Filed: Apr. 18, 2016

(51) Int. Cl. B65H 16/00; E04F 19/04; B62B 3/04

(52) U.S. Cl. CPC B65H 16/005; B62B 3/04; E04F 19/04

(57) ABSTRACT

A baseboard dispensing assembly includes a pair of plates including an upper plate and a lower plate. The upper plate is positioned on and attached to the lower plate. The upper and lower plates are rotatable with respect to each other. The upper plate has an upper surface and the lower plate has a lower surface. A securing member is attached to the upper surface and is configured to restrict the coil of the flexible baseboard from sliding off of the upper surface. The upper plate receives a coil of flexible baseboard such that the coil is uncoiled while the securing member retains the coil on the upper plate.

### BACKGROUND OF THE DISCLOSURE

### Field of the Disclosure

The disclosure relates to baseboard transporting and uncoiling devices and more particularly pertains to a new baseboard transporting and uncoiling device to facilitate the transportation and unwinding of a coil of flexible baseboard material.

### SUMMARY OF THE DISCLOSURE

An embodiment of the disclosure meets the needs presented above by generally comprising a pair of plates including an upper plate and a lower plate. The upper plate is positioned on and attached to the lower plate. The upper and lower plates are rotatable with respect to each other. The upper plate has an upper surface and the lower plate has a lower surface. A securing member is attached to the upper surface and is configured to restrict the coil of the flexible baseboard from sliding off of the upper surface. The upper plate is configured to receive a coil of flexible baseboard such that the coil is uncoiled while the securing member retains the coil on the upper plate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a baseboard dispensing assembly according to an embodiment of the disclosure.

FIG. 2 is a bottom perspective view of an embodiment of the disclosure.

FIG. 3 is a top view of an embodiment of the disclosure.

FIG. 4 is a side view of an embodiment of the disclosure.

FIG. 5 is a cross-sectional view of an embodiment of the disclosure taken along line 5-5 of FIG. 1.

### DESCRIPTION OF THE PREFERRED EMBODIMENT

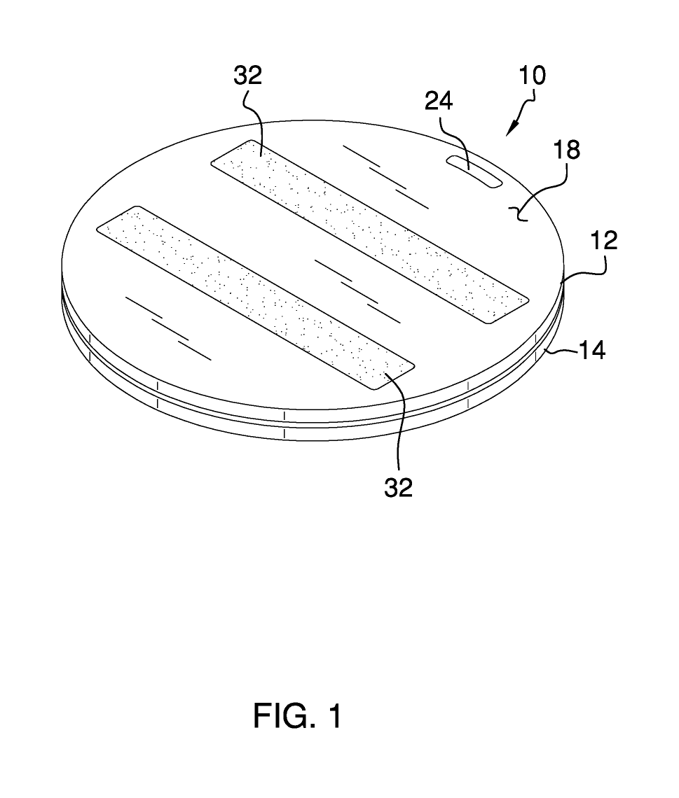

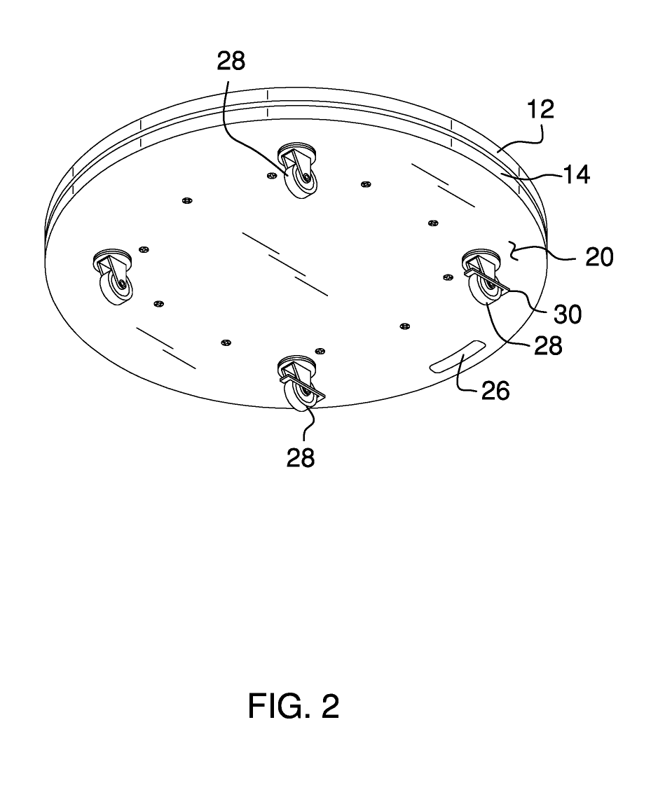

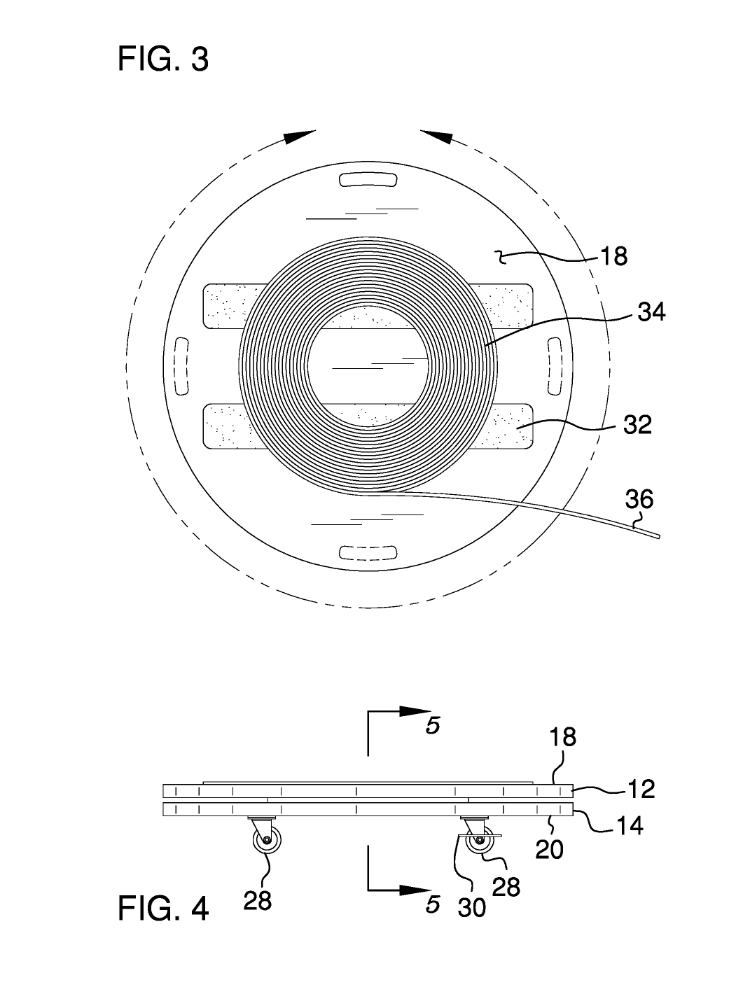

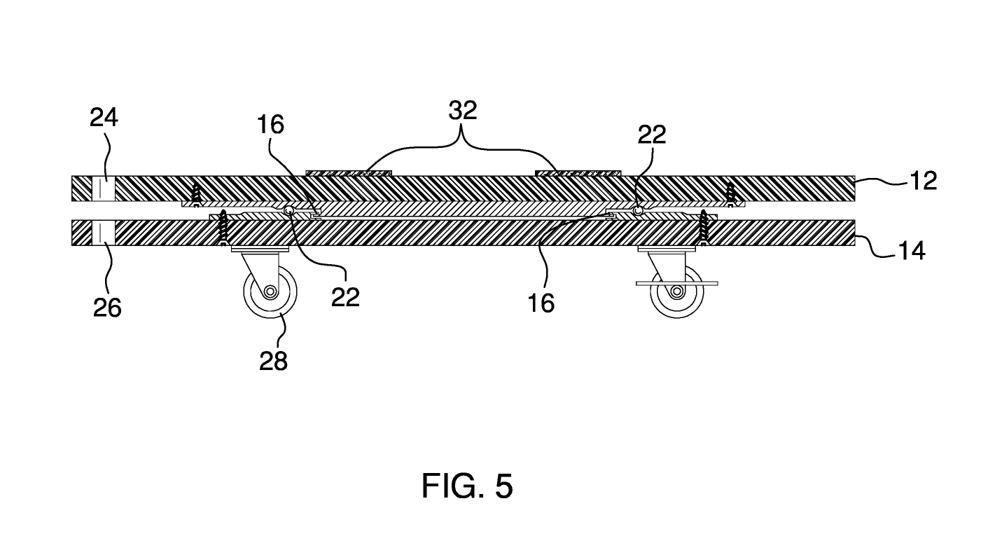

With reference now to the drawings, and in particular to FIGS. 1 through 5 thereof, a new baseboard transporting and uncoiling device embodying the principles and concepts of an embodiment of the disclosure and generally designated by the reference numeral 10 will be described.

As best illustrated in FIGS. 1 through 5, the baseboard dispensing assembly 10 generally comprises a pair of plates including an upper plate 12 and a lower plate 14. The upper 12 and lower 14 plates are comprised of a rigid material such as wood, plastic, metals and the like. The upper plate 12 is positioned on and attached to the lower plate 14. The upper 12 and lower 14 plates are rotatable with respect to each other. As can be seen in the figures, interlocking flanges 16 may be utilized to attach together the upper 12 and lower 14 plates. The upper plate 12 has a circular shape and has a diameter between 25.0 inches and 36.0 inches. The lower plate 14 may have a same size and shape as the upper plate 12. The upper plate 12 has an upper surface 18 and the lower plate 14 has a lower surface 20. A plurality of bearings 22 may be positioned between and engage the upper 12 and lower 14 plates to promote rotation of the upper 12 and lower 14 plates with respect to each other. An aperture 24 extends through the upper plate 12 to allow the assembly 10 to be lifted and the lower plate 14 may include an opening 26 which is alignable with the aperture 24.

A plurality of wheels 28 is rotatably and pivotably coupled to the lower surface 20. At least one of the wheels 28 may be lockable, with a stop member 30, to prevent rotation when the at least one of the wheels 28 is in a locked condition. The wheels 28 may comprise conventional castors.

A securing member 32 is attached to the upper surface 18 and is configured to restrict a coil 34 of flexible baseboard 36 from sliding off the upper surface 18. The securing member 32 may comprise a non-slip material having a high co-efficient of friction that is positioned on the upper surface 18. The non-slip material comprises multiple strips of non-slip material positioned on the upper surface 18 and which are spaced from each other. The upper plate 12 is configured to receive the coil 34 of flexible baseboard 36 such that the coil 34 is uncoiled while the securing member 32 retains the coil 34 on the upper plate 12.

In use, a coil 34 of flexible baseboard, or cove base, is positioned on the upper plate 12 so that the baseboard 36 can be moved where needed. When the baseboard 36 is being unwound from the coil 34, the stop member 30 is engaged and the baseboard 36 is easily unwound by pulling it as the upper plate 12 rotates. In this a manner the baseboard 36 may be quickly attached to a wall as an installer moves along the bottom edge of the wall.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A flexible baseboard transportation and delivery assembly configured to support and facilitate unwinding of flexible baseboard from a coil of the flexible baseboard, said assembly comprising:
a pair of plates including an upper plate and a lower plate, said upper plate being positioned on and attached to said lower plate, said upper and lower plates being rotatable with respect to each other, said upper plate having an upper surface and said lower plate having a lower surface;
a securing member being attached to said upper surface and being configured to restrict the coil of the flexible baseboard from sliding off said upper surface; and
wherein said upper plate is configured to receive a coil of flexible baseboard such that the coil is uncoiled while said securing member retains the coil on said upper plate.

2. The flexible baseboard transportation and delivery assembly according to claim 1, wherein said upper plate has a circular shape and has a diameter between 25.0 inches and 36.0 inches.

3. The flexible baseboard transportation and delivery assembly according to claim 1, further including a plurality of bearings being positioned between and engaging said upper and lower plates.

4. The flexible baseboard transportation and delivery assembly according to claim 1, further including a plurality of wheels being rotatably and pivotably coupled to said lower surface.

5. The flexible baseboard transportation and delivery assembly according to claim 4, wherein at least one of said wheels is lockable to prevent rotation when said at least one of said wheels is in a locked condition.

6. The flexible baseboard transportation and delivery assembly according to claim 1, wherein said securing member comprises a non-slip material being positioned on said upper surface.

7. The flexible baseboard transportation and delivery assembly according to claim 6, wherein said non-slip material comprises multiple strips of non-slip material.

8. A flexible baseboard transportation and delivery assembly configured to support and facilitate unwinding of flexible baseboard from a coil of the flexible baseboard, said assembly comprising:
a pair of plates including an upper plate and a lower plate, said upper plate being positioned on and attached to said lower plate, said upper and lower plates being rotatable with respect to each other, said upper plate having a circular shape and having a diameter between 25.0 inches and 36.0 inches, said upper plate having an upper surface and said lower plate having a lower surface, a plurality of bearings being positioned between and engaging said upper and lower plates;
a plurality of wheels being rotatably and pivotably coupled to said lower surface, at least one of said wheels being lockable to prevent rotation when said at least one of said wheels is in a locked condition;
a securing member being attached to said upper surface and being configured to restrict the coil of the flexible baseboard from sliding off said upper surface, said securing member comprising a non-slip material being positioned on said upper surface, said non-slip material comprising multiple strips of non-slip material;
wherein said upper plate is configured to receive a coil of flexible baseboard such that the coil is uncoiled while said securing member retains the coil on said upper plate.
